(19) United States
(12) Patent Application Publication
(10) Pub. No.: US 2009/0125649 A1
(43) Pub. Date: May 14, 2009

(54) VARIABLE SPEED BUFFER SERVO CONTROL FOR LINEAR TAPE DRIVES

(76) Inventors: Turguy GOKER, Solana Beach, CA (US); Hoa Le, Orange, CA (US); Shelby D. Wold, Rancho Santa Margarita, CA (US)

Correspondence Address: MORRISON & FOERSTER LLP, 755 PAGE MILL RD, PALO ALTO, CA, 94304-1018, US

(21) Appl. No.: 11/940,281

(22) Filed: Nov. 14, 2007

(51) Int. Cl. G06F 5/14

(52) U.S. Cl. 710/57

(57) ABSTRACT

A variable speed linear tape drive includes a driver portion for rotating a supply reel of a tape cartridge having storage media spooled therein, a motor coupled to rotate the driver portion, a controller configured to control the motor in accordance with a control algorithm, an interface for one or more of sending data to and receiving data from a host; and a buffer for storing one or more of data received from the host and data to be transmitted to the host, the buffer operable to supply a buffer fill level indication to the controller, wherein the control algorithm is operable to generate a difference between a target buffer fill level and the buffer fill level indication and adjust at least one of an angular velocity or an acceleration of the motor to reduce the difference.

### BACKGROUND

1. Field

The present invention relates generally to linear tape drives, and more particularly to methods and apparatus for variably controlling the speed of a linear tape drive.

2. Description of Related Art

A linear tape drive receives data from and sends data to a host over an interface (a host interface). A rate at which the host can send and/or receive data over the interface can vary depending on the tape drive, host, the interface, as well as dynamically during varying operating conditions. For example, the host can interface over a gigabit Ethernet connection or a SCSI interface to the tape drive; combination interfaces such as SCSI over Ethernet can also be employed. These different interfaces can have different data rates, dynamic variations, latencies, and the like. As such, information that the host can accept from or transmit to the tape drive may vary widely.

Generally, system designers attempt to match the raw speed of the drive, the interface, and the host to each other. However, this is an imperfect solution that constrains the variety of solutions available and also does not comprehend dynamic system conditions. Providing a large buffer between the physical tape drive and the interface can help, as this helps decouple the native transfer rate of the drive from that of the host interface. A large buffer may be costly, and may only work within a range of conditions. If the data transfer rate of tape drives continues to diverge from the typical speeds of host interfaces, then such buffer solutions will be less effective. Also, in non-variable speed drive systems, when the drive runs out of information to write or the host cannot accept more information, the drive will back hitch or stop at maximum tape speed and with high acceleration and deceleration rates to minimize dead time. Such frequent back hitches can cause tape edge wear and also tape packing issues, due to stagger wraps and air entrainment. High speed and high acceleration maneuvers also require comparatively high power and potentially more robust drive components.

Variable speed tape drives have also been used to try to match a speed of the tape drive to the current transfer rate of the host interface. However, the art continues to evidence a demand for improvements in controlling such variable speed tape drives for both steady state operation and to account for dynamic changes.

### SUMMARY

In general, in a first aspect, the invention features a variable speed linear tape drive. The tape drive includes a driver portion for rotating a driven portion of a tape cartridge having storage media spooled therein, a motor coupled to rotate the driver portion, a controller configured to control the motor in accordance with a control algorithm, an interface for one or more of sending data to and receiving data from a host; and a buffer for storing one or more of data received from the host and data to be transmitted to the host, the buffer operable to supply a buffer fill level indication to the controller; wherein the control algorithm is operable to generate a difference between a target buffer fill level and the buffer fill level indication and adjust at least one of an angular velocity or an acceleration of the motor to reduce the difference.

Embodiments of the invention may include one or more of the following features. The control algorithm may implement a time optimum seek and track of the selected buffer target algorithm. The time optimum seek and track algorithm may output motor control signals for angular velocity and acceleration rate. The seek and track algorithm may reduce the magnitude of the acceleration rate in response to a reduction in the magnitude of the difference. The seek and track algorithm may include a proportional integral differential (PID) controller, an integrator with lead/lag compensation, a linear quadratic regulator, an H-Infinity control, or a combination thereof. The target buffer fill level may be selectable according to a state of either a write or a read in progress. The state may be describable by state selected from: a mid-tape state, a corner turn state, and a seek state. The target fill level for the corner turn state may be set at a relatively full level in order to reduce the buffer fill level prior to an end of the storage media, causing reversal of direction of the media.

In general, in a second aspect, the invention features a servo system for implementing a variable speed linear tape drive to read from and/or write to storage media in a tape cartridge. The servo system includes circuitry for selecting a target fill level of a buffer operable to store read data to be transmitted to a host and/or data received from the host to be written to the storage media, the target fill level selected based at least on an amount of the storage media remaining in the tape cartridge, circuitry to periodically generate an indication of an actual fill level of the buffer, circuitry to produce a difference between the target fill level and the actual fill level, and optimization circuitry to implement an algorithm for reducing the difference.

Embodiments of the invention may include one or more of the following features. The optimization circuitry may track the actual fill level to within a tolerance of the initial target to achieve a lock. After achieving a lock, the optimization circuitry may track the actual fill level to an end target level at a slew rate selected to avoid recorded data density mismatches on the tape.

In general, in a third aspect, the invention features a method for writing data to media in a cartridge in a variable speed linear tape drive system. The method includes storing, in a buffer, data received from a host prior to writing the data to the media, determining that the media in the cartridge is nearing a position for reversal of a direction of movement of the media through the drive, in response to the determination, operating the tape drive at a higher write rate to cause the buffer to become more available, receiving data from the host in the buffer during the reversal of media movement direction, and resuming writing the data to the host at a rate selected to at least postpone emptying the buffer.

Embodiments of the invention may include one or more of the following features. Determining may also include determining whether the drive can operate at a higher write rate.

In general, in a fourth aspect, the invention features a method of operating a variable speed linear tape drive for reading from and writing to a storage tape. The method includes selecting a target fill level for a buffer for storing one or more of data received from a host and data to be transmitted to the host, generating a signal indicative of a difference between an actual fill level and the target fill level of the buffer, and adjusting a speed of the tape for reducing the difference by using a feedback system that attempts to minimize the difference signal.

Embodiments of the invention may include one or more of the following features. The method may further include adjusting an acceleration of the tape. The method may further include selecting the target fill level based at least in part on whether the tape drive is approaching an end of the tape. The target fill level may be a comparatively full position if the tape drive is approaching an end of the tape.

In general, in a fifth aspect, the invention features a method for adjusting the speed of a variable speed tape drive. The method includes selecting a target speed based on one or more of an estimate of a data transfer rate from a host computer and a position of the tape during a data transfer operation accessing the tape, the target speed selected by a servo receiving as feedback a difference between a target fill level of a buffer and an actual fill level of the buffer.

In general, in a sixth aspect, the invention features a computer-readable medium comprising instructions for writing data to media in a cartridge in a variable speed linear tape drive system, the instructions for storing, in a buffer, data received from a host prior to writing the data to the media, determining that the media in the cartridge is nearing a position for reversal of a direction of movement of the media through the drive, in response to the determination, operating the tape drive at a higher write rate to cause the buffer to become more available, receiving data from the host in the buffer during the reversal of media movement direction; and resuming writing the data to the host at a rate selected to at least postpone emptying the buffer.

Embodiments of the invention may include one or more of the following features. Determining may also include determining whether the drive can operate at a higher write rate.

In general, in a seventh aspect, the invention features a computer-readable medium comprising instructions for operating a variable speed linear tape drive for reading from or writing to a storage tape, the instructions for selecting a target fill level for a buffer for storing one or more of data received from a host and data to be transmitted to the host, generating a signal indicative of a difference between an actual fill level and the target fill level of the buffer, and adjusting a speed of the tape for reducing the difference by using a feedback system that attempts to minimize the difference signal.

Embodiments of the invention may include one or more of the following features. The instructions may further include adjusting an acceleration of the tape. The instructions may further include selecting the target fill level based at least in part on whether the tape drive is approaching an end of the tape. The target fill level may be a comparatively full position if the tape drive is approaching an end of the tape.

In general, in an eighth aspect, the invention features a computer-readable medium comprising instructions for adjusting the speed of a variable speed tape drive, the instructions for selecting a target speed based on one or more of an estimate of a data transfer rate from a host computer and a position of the tape during a data transfer operation accessing the tape, the target speed selected by a servo receiving as feedback a difference between a target fill level of a buffer and an actual fill level of the buffer.

In general, in a ninth aspect, the invention features a data storage system having a controller and a tape drive. The data storage system includes a closed loop servo system based upon a linearized model, a memory buffer for storing data, wherein the memory buffer is associated with a buffer fill level indication, a control algorithm operable to adjust at least one of an angular velocity or an acceleration of the tape drive based upon the buffer fill level indication, wherein the closed loop system is operable to adjust a speed of the tape through the drive independently of a host transfer rate, and in response to at least one disturbance, at least a portion of the memory buffer space remains available for storing data.

Embodiments of the invention may include one or more of the following features. The at least one disturbance may include a variation in data density, a burst of data, variation of a clock rate, a request by the host to transfer data, or a combination thereof. The at least one disturbance may non-adversely affect performance of the data storage system. The control algorithm may include a proportional integral differential (PID) controller. The proportional integral differential controller may be associated with a bandwidth, and the closed loop servo system may be operable to follow the disturbance within a range defined by the bandwidth. The control algorithm may include an integrator with lead/lag compensation. The control algorithm may include a linear quadratic regulator. The control algorithm may include an H-Infinity control.

### BRIEF DESCRIPTION OF THE DRAWINGS

The present application can be best understood by reference to the following description taken in conjunction with the accompanying drawing figures, in which like parts may be referred to by like numerals:

FIG. 1 is an illustrative block diagram of a system in accordance with embodiments of the invention.

FIG. 2 illustrates a buffer in accordance with embodiments of the invention.

FIG. 3 illustrates a block diagram of a portion of the system in accordance with embodiments of the invention.

FIG. 4 is an illustrative block diagram of a servo control block in accordance with embodiments of the invention.

FIG. 5 is an illustrative block diagram of a servo algorithm in accordance with embodiments of the invention.

FIG. 6 illustrates the operation of a gain element in accordance with embodiments of the invention.

FIG. 7 is an illustrative block diagram of a PID controller in accordance with embodiments of the invention.

FIG. 8 is an illustrative Bode diagram for a filter in accordance with embodiments of the invention.

FIG. 9 is an illustrative Simulink block diagram for a filter in accordance with embodiments of the invention.

FIG. 10 illustrates a method of filtering to arrive at a clock rate for output in accordance with embodiments of the invention.

FIG. 11 illustrates a method for writing to tape in a tape drive having servo control of tape speed in accordance with embodiments of the invention.

FIGS. 12 and 13 illustrate simulated operation of a system in accordance with embodiments of the invention.

FIGS. 14 and 15 illustrate test results for a system in accordance with embodiments of the invention.

FIG. 16 illustrates a typical computing system that may be employed to implement processing functionality in accordance with embodiments of the invention.

### DETAILED DESCRIPTION

The following description is presented to enable a person of ordinary skill in the art to make and use various aspects of the inventions. Descriptions of specific materials, techniques, and applications are provided only as examples. Various modifications to the examples described herein will be readily apparent to those skilled in the art from these disclosures, and the general principles defined herein may be applied to other examples and applications without departing from the spirit and scope of the inventions.

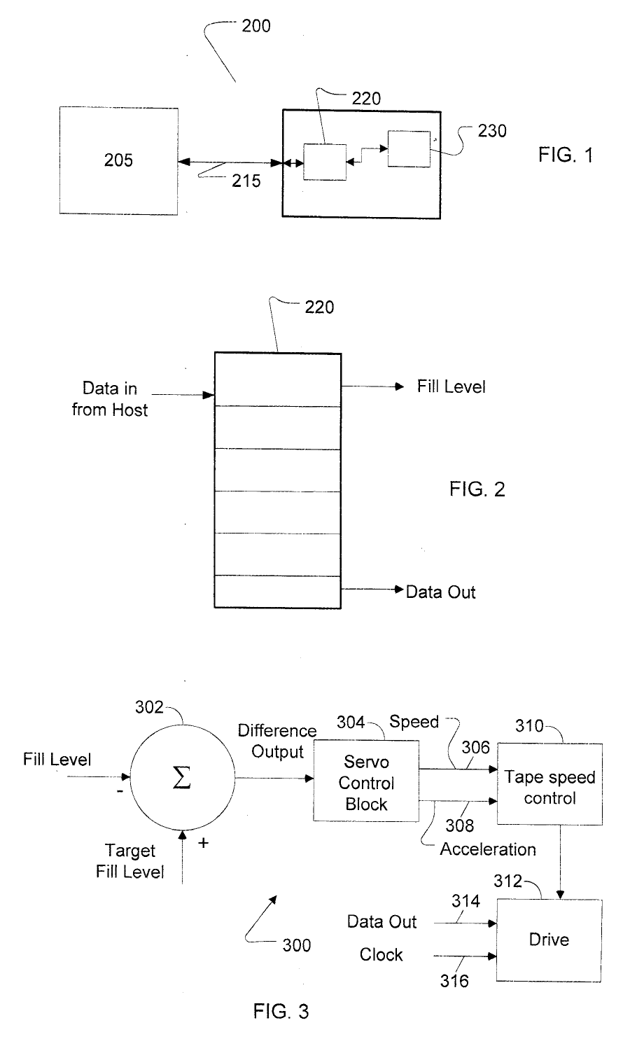

Aspects of the invention will be described with reference to FIG. 1 that illustrates a block diagram of a system 200. System 200 includes a host interface 215 that inputs and/or outputs data to/from a buffer 220, which in turn communicates with a read/write system 230, which includes components including at least one read/write head to read and write data to and from a tape cartridge accessed by the read/write system 230. For example, the tape cartridge may be inserted in a slot and the tape pulled from a spool in the cartridge and passed over the read/write head to read and/or write data to/from the tape. The buffer 220 is illustrated in further detail in FIG. 2, which illustrates that, in accordance with embodiments of the invention, the buffer includes a data in port, a fill level indication output, and a data out port to the read/write system 230.

In a first aspect, there is provided a method for tracking a data buffer fill level to a target value based on an optimization algorithm that may comprise using servo technology, such as a Time Optimum Seek and Track servo adapted as described herein. The tracking can be accomplished by adjusting an amount of data written to or read from the tape by adjusting a speed of the tape moving past the read/write head while recording/reading at a nominally fixed data density.

As will be explained in further detail herein, this aspect treats the host transfer rate (read and/or write) as a disturbance in the system, along with other potential disturbances, such as variations in data density, bursty data streams, clock rate variation, and other aspects that cause some variation in the rate of data transfer between the host and the tape. Such disturbances can cause non-linearities in the rate of data that the host can receive or provide for writing over time. The servo system operates to linearize these disturbances and adapt to them. That is, a closed-loop servo system that uses a linearized model is used to linearize tape drive operation in response to disturbances such as variations in the host transfer rate, variations in data density, bursty data streams, clock rate variation, and other aspects. This treatment allows avoidance of depending directly on a measurement or estimate of the host transfer rate for adjusting a speed of the tape through the drive.

FIG. 3 illustrates a block diagram of a portion of a system 300 in accordance with embodiments of the invention. The portion includes a summing junction 302 that generates a signal indicative of a difference between a target buffer fill level and the buffer fill level presented by the output from the buffer 220. That signal is fed into a servo control block 304, which generates a speed control signal 306 and an acceleration control signal 308. The speed and acceleration control signals 306, 308 are fed into a tape controller 310 that translates the control signals 306, 308 into outputs appropriate for driving the actuator (e.g., the motor of a drive 312) that turns the reel on which the tape is spooled.

The drive 312 receives data out 314 from the buffer 220 (during a write mode; read mode would be the reverse of this example) and a clock signal 316 for timing when the data should be written (or read, for read mode).

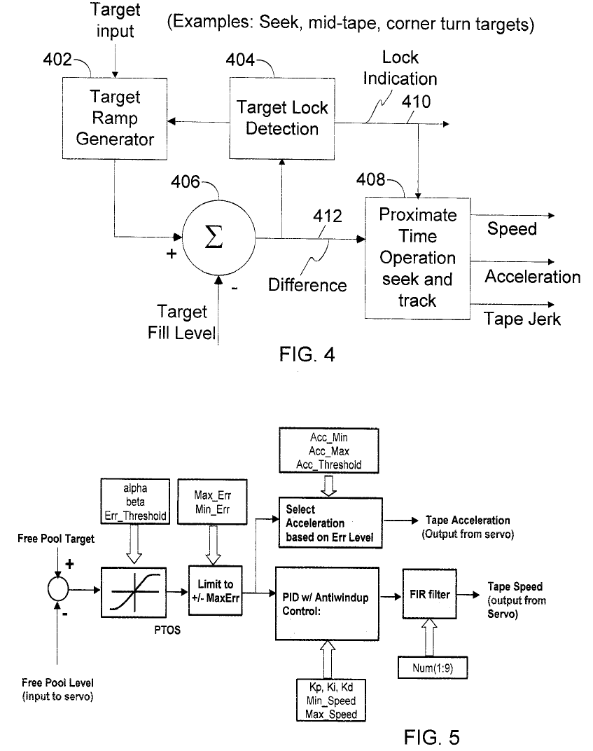

FIG. 4 illustrates a block diagram of the servo control block in accordance with embodiments of the invention. The servo control block includes a target ramp generator 402 that receives a target buffer level input signal selected according to example aspects described below. During seek mode, the ramp generator 402 generates a ramp function that is fed into a summing junction 406 to generate a difference signal 412 as described above. A target lock detection block 404 feeds back to the ramp generator and also provides a lock indication 410 to the Proximate Time Optimum (PTO) seek and track block 408. The difference signal 412 is also input to the PTO seek and track block 408. The PTO seek and track block 408 outputs the speed and acceleration signals described above, as well as a tape jerk signal as appropriate.

A servo algorithm block diagram is illustrated in FIG. 5 in accordance with embodiments of the invention. The algorithm includes a gain block (labeled PTOS). The output of the gain block is further limited in a limiter that receives as input max error and min error variables. The limited difference signal is output from the limiter and input to a servo control mechanism such as a Proportional Integral Differential (PID) controller with antiwindup control. The PID controller is configured with gains comprising an integral gain Ki, a differential gain Kd, and a proportional gain Kp. The PID controller also is configured with a min speed and a max speed that can be selected by the controller. The output of the PID controller can be filtered with an FIR filter to smooth changes in the speed. Other types of servo control mechanisms may be used to compensate the loop instead of or in addition to the PID controller, as known to those skilled in the art. For example, the servo control mechanism may include an integrator with lead/lag compensation, or a linear quadratic regulator, or H-Infinity controls. The PID is used for illustrative purposes in this example.

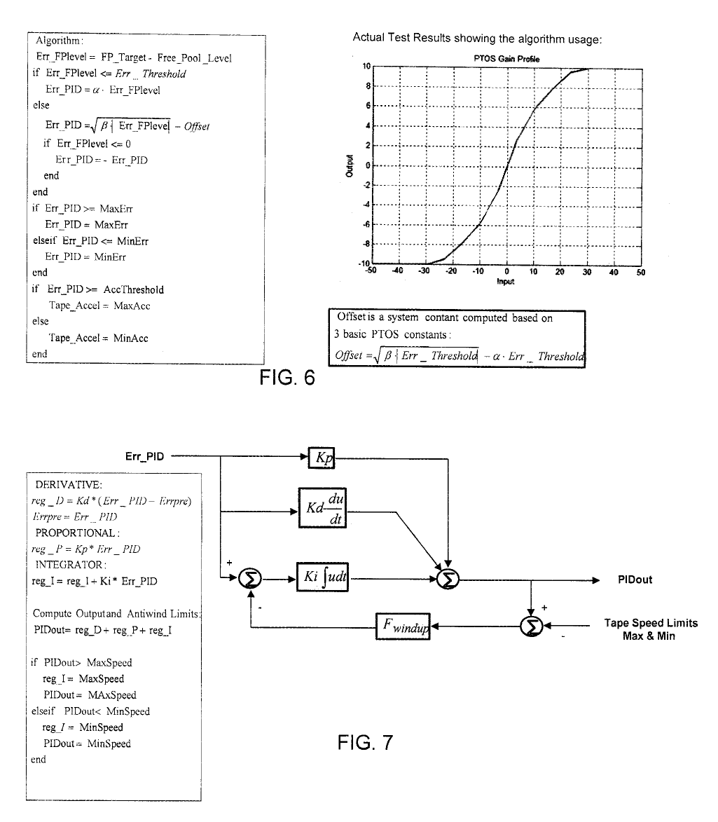

FIG. 6 illustrates the operation of a gain element in accordance with embodiments of the invention. The difference between the target buffer fill level and the buffer fill level are fed into the gain element. The behavior of this system element is summarized by the algorithm presented with the figure illustrating the PTOS gain profile. A purpose of this is to adjust the servo gain in order to minimize the overshoot of the target buffer level (a Time Optimum square root error calculation that adjusts the servo gain).

FIG. 7 illustrates a block diagram of the PID controller. The difference signal is modified by Kp, and summed with the derivative of the output multiplied by Kd and the integral of the output multiplied by Ki. The output of the summer is the PID output. The PID output is subtracted from the max and min tape speed limits and the difference is used as an indication of actuator saturation and is used as a subtractive term to the integral, which helps keep the system from saturating and becoming insensitive to feedback. The code listing in the figure provides further information as to the operation of the PID controller.

The limited difference signal is also sent to circuitry that is operable to select a tape acceleration based on a magnitude of the difference signal—a larger difference signal causes selection of a larger acceleration, and a smaller difference signal causes a smaller acceleration.

The operation of this system includes that at start up, a Track flag is reset, which causes the system to start in Seek mode. The Target Buffer Level is initiated to a mid point of the available buffer space. For example, a buffer may comprise 128 data segments of storage, and the Target may be set at 64 data segments full/empty. The system determines the difference (preferably an absolute difference) between the actual buffer fill level and the target level. If the difference is within a limit—e.g., within some percentage of the total buffer size, then the system increments an on track counter, and loops to again determine the difference at a subsequent time. If the difference is sufficiently small for a number of iterations (e.g., 100 interrupts), then the system determines that the system has tracked the actual buffer fill level to the target level.

Thereafter, the system enters tracking mode. In tracking mode, the system can cause the actual buffer fill level to track to a different target fill level. To avoid sudden jumps in data density, the system can ramp the rate at which the system causes the actual fill level to converge on the target fill level. For example, the system can ramp the target fill level used to formulate the different at a fraction of a total amount of change between the actual fill level and the desired target level. As the system tracks the actual fill level to each intermediate target level, the system continues to modify the target until an ultimate target has been achieved.

Aspects of the invention include selecting a target buffer fill level for a particular circumstance or during a particular point in tape drive operation. For example, controlling a fill level of the buffer can help reduce disconnects between the host and drive, such that the host can transfer data whenever it can (read or write.)

By selecting the target level near full condition, low speed back hitch motion that enables lower power operation and less air entrainment as a result of back hitch. This is accomplished due to the drive slowing down while transferring data from a nearly full buffer and achieving a low operating tape speed when buffer finally empties out.

By lowering the target level near empty, the system forces the drive to operate at higher speeds emptying the buffer as the tape reaches an end. Therefore, the host is not disconnected as the tape drive turns the corners. For hosts with lower transfer rates this can be useful since such host would have reduced transmission downtime (times when the tape drive does not accept data from or provide data to the host), which would increase overall system throughput.

When operating with systems that have high burst rates the optimization algorithm may lower the target level towards the mid point therefore providing head room to adjust the speed to accommodate a sudden burst of traffic to/from the host.

In exemplary aspects, these guidelines can be programmed into circuitry or software running on hardware. These are of course guidelines and are not to be understood as hard limits one way or the other, since the example goals achieved with a wide range of such variables, as informed by the particular configuration of each system. Advantages can also be had by partial implementations of aspects described herein. For example, an algorithm for selecting target buffer levels can be more or less aggressive. A more aggressive algorithm may achieve somewhat better results, e.g., somewhat fewer back hitches than a less aggressive algorithm, but the less aggressive algorithm will still result in fewer back hitches and lower speed back hitches than an implementation not in accordance with the present aspects.

At system start, a target buffer level may be set near a mid-point such that seeking can occur from that mid-point. After obtaining a sync, the mode is changed track, which allows a ramp to the ultimate desired target value for the buffer space. At a mid-point in writing the tape, a near full buffer target can be set. This provides a situation where even if the host does not transfer data for some time, the tape drive can proceed to write at a reduced rate without having to hitchback. Additionally, if there is a hitchback, the hitchback can be done at a much slower speed than a full speed at which many drives presently are implemented.

As an end of tape approaches, a target buffer level may be set near empty. This causes the drive to increase the speed of writing such that the buffer will empty prior to the end of tape being reached. Once the end of the tape is reached, the tape direction must be reversed. This takes some time. Thus, by providing a larger amount of buffer to accommodate transmissions from the host during the time that the tape drive cannot write data, the chance that the host can transmit at maximum capacity is increased. Note that the above scenarios would be reversed for a read operation.

The servo implements the change to the target buffer level by adjusting a speed of the tape, and can also adjust the acceleration of the tape to avoid overshooting the target as the difference between an actual and a target buffer level converge.

FIG. 11 illustrates steps in a method for writing to tape in a tape drive having servo control of tape speed. To start, the tape drive begins to rotate in response to a write request. At block 1102, the drive initializes the servo registers described above as well as a selecting an initial rotation speed. At block 1108, the drive checks whether it is time to start writing or not. If it is not yet time to start writing, the drive continues ramping to the target speed. Meanwhile, the buffer may be receiving data from the host at blocks 1104 and 1106. If it is time to write, then the system may begin the seek and track algorithm. The term “seek and track” as used herein indicates that the system attempt to reach a specified buffer fill level, and attempts to maintain that buffer fill level.

First, at block 1110, the seek algorithm attempts to synchronize the buffer fill level to the seek buffer fill level—for example—½ full. This synchronization helps the system get to a known, safe state from which various servo strategies can proceed. After achieving a lock, then the track algorithm controls the drive speed based on a difference signal between a target buffer level and an actual buffer level. While writing is enabled, the drive will continue to track and loop, with write(s) occurring at block 1114. If writing is not enabled, then the drive waits at block 1116, for example, during a reposition. After the wait, the drive can return to an initial state and restart the algorithm.

Because the example systems vary the speed of tape through the tape drive (i.e., the speed at which the tape moves past read/write heads in the tape drive), the density of data on the tape would vary unless a clock controlling the frequency at which data is written is adjusted to compensate for the variation in tape speed. Variation in recorded data density may be acceptable for some applications. However, other applications require such variation to be within defined limits. For example, the LTO recording format specification requires:

(1) Long Term average Bit Cell Length: Over 5000 servo frames (approximately 1 m of tape) the average Bit Cell Length is be ±0.5% of the nominal length.

(2) Short Term average Bit Cell Length: Over 393 bit cells; the average is be within 4% of the nominal value. This is called STA.

(3) Rate of Change of Short Tem Average: Rate of change of STA over any consecutive 393-bit cell sections shall be within 0.8%.

Recording density can be described by the length of recorded bit cells, expressed as a tape velocity divided by the clock frequency: L=V/F where L is the bit cell length, V is the speed (generally expressed in meters per second) and F is the clock frequency in Hz:

Therefore, for the example LTO format specification, L should remain within the parameters (1)-(3) above.

A clock adaptation algorithm may take the following steps to keep the write clock within a desired specification

(1) Read one or more Position Error Signal (PES) Speeds from sensors, as is known in the art. (can sample a default and if not valid, them sample another head).

(2) if there is no valid PES speed, then the process stops without updating the write clock, and if there is a valid PES speed then:

Execute the Filter algorithm described below.

Compute a Speed-Ratio based on Target Speed and the filtered speed defined as 1+(FiltSpeed−TargetSpeed)*(1/TargetSpeed)

Check to see if the Speed-Ratio is within the window of 0.97 to 1.03 (this step provides a 3% window to adjust Write clock to account for a range of the PLL—and may vary in implementations).

Also, before the Write Clock register is updated, a slew rate limitation check can be done. Limiting slew rate helps avoid a data splice mismatch, where there is a disconnect in the recording density between two adjacent points on the tape. This entails:

Computing the new Clock based on the Speed_Ratio, Clock_new

Read the ELSA HW Clock register before updating it, call the read value Clock_old.

Calculate Clock_Error=Clock_old−Clock_new

If abs (Clock_Error)<0.008*Clock_Old then that can be considered a good value for updating the register. If abs (Clock_Error)>=0.008*Clock_Old then updating the write clock register with the new clock value may cause a density splice problem.

In such circumstances, a ramped approach to moving from the old clock frequency to the new one may be conducted, as described below:

If Clock_error>0 subtract deltaStep=[0.008*Clock_Old/2] from the Clock_Old and update Write Clock Reg.

If Clock_error<0 add deltaStep=[0.008*Clock_Old/2] to the Clock_Old and update Write Clock Reg.

Diagnostic data may be collected for the above routine to determine how often ramped clock adjust is required. The above exemplary values are for illustration purposes. For example, a slew rate limiter may be more or less aggressive, a PLL may have a greater or a narrower range, and a recording specification may be more or less stringent. Based on the above disclosure, one of ordinary skill would comprehend that such differences can be comprehended in the above algorithm.

Filter Algorithm for Clock Adaptation:

This example algorithm uses cascaded 32 2^{nd} order stage IIR filters to process PES Speed data to compute a filtered tape speed that will be used to compute the next value of Write Clock.

| Stage | Natural Freq Hz | Damping |
|---|---|---|
| 1 | 410 | 0.7787 |
| 2 | 522 | 0.7000 |
| 3 | 550 | 0.55 |

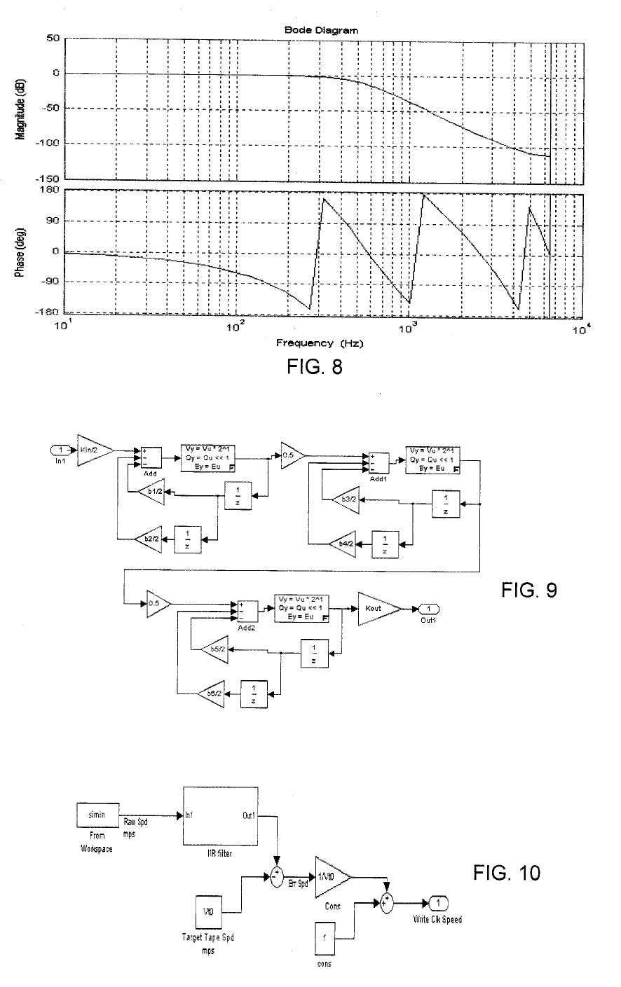

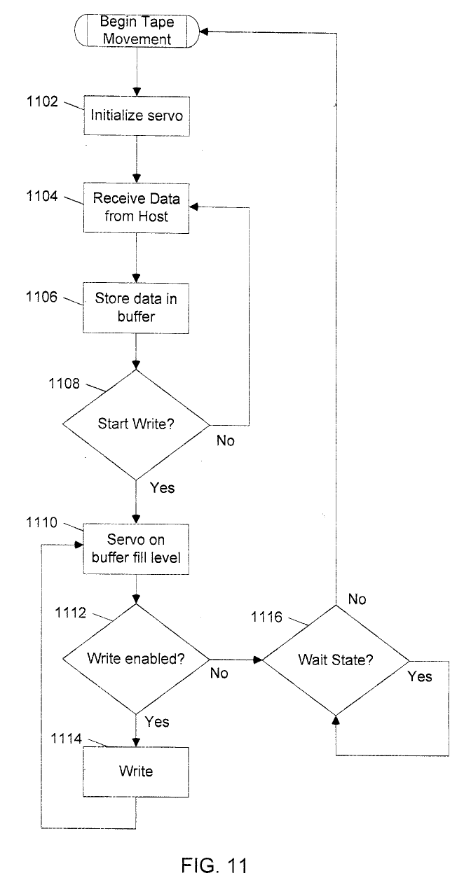

A Bode diagram for the filter is illustrated in FIG. 8.

This algorithm can be implemented using fixed point math by distributing gains to eliminate DC errors caused by quantization. FIG. 9 is a Simulink block diagram of the filter. Coefficients used in the filter are:

| Name | Value |
|---|---|
| Kin | 0.2500 |
| B1 | −1.70114627989379 |
| B2 | 0.73474649614422 |
| B3 | −1.64973529558894 |
| B4 | 0.70296598588455 |
| B5 | −1.68587626764731 |
| B6 | 0.74667656670364 |
| Kout | 4.349805894023584e−004 |

The block diagram showing filtering to ultimately arrive at a clock rate for output (the writing example given here) is illustrated in FIG. 11.

Finally, the equation to convert the Write Clk Speed to the Frequency is:
System Clock is 120 MHz for ELSA ASIC
LTO3 density is 10240 cells/mm
LTO2 density is 7860 cells/mm
Tape Speed is m/s
density is cells/mm
DSS_CFG is frequency selection

$$DS\_CFG = \frac{TapeSpeed * Density * 1000}{0.7152557}$$

In the read mode according to these aspects, there can be a tape speed variation, as well as incoming prewritten Bit Cell length variation. Therefore , a PLL tracking the data stream will have to follow an input frequency that varies as a result of 2 different variations.

PLL input Frequency as a result of L and Read Mode tape speed variations can be described by the equation:

$${F}_{r d} = \frac{{V}_{r d}}{L} = \frac{{V}_{0} \cdot [ 1 + \frac{Δ {V}_{r d}}{{V}_{0}} ]}{{L}_{0} \cdot [ 1 + \frac{Δ L}{{L}_{0}} ]} = {F}_{0} \cdot \frac{1 + \frac{Δ {V}_{r d}}{{V}_{0}}}{1 + \frac{Δ L}{{L}_{0}}}$$

A ratio of Read Mode to Nominal frequency can be computed as a function of Read Mode speed variations and written in Bit Cell Length variations:

$$\frac{{F}_{r d}}{{F}_{0}} = \frac{1 + \frac{Δ {V}_{r d}}{{V}_{0}}}{1 + \frac{Δ L}{{L}_{0}}} = \frac{\frac{{V}_{r d}}{{V}_{0}}}{1 + \frac{Δ L}{{L}_{0}}}$$

$$\frac{{V}_{r d}}{{V}_{0}} = \frac{{F}_{r d}}{{F}_{0}} \cdot [ 1 + \frac{Δ L}{{L}_{0}} ]$$

Therefore, an equation that computes the STA Density as a function frequency ratio and speed ratio terms can be derived, and is provided below:

$${STA}_{rate \%} = 100 \frac{{STA}_{n} - {STA}_{n + 1}}{{STA}_{n}} = 100 \frac{{L}_{0} ( 1 + \frac{Δ {L}_{n}}{{L}_{0}} ) - {L}_{0} ( 1 + \frac{Δ {L}_{n + 1}}{{L}_{0}} )}{{L}_{0} ( 1 + \frac{Δ {L}_{n}}{{L}_{0}} )}$$

A PLL is based on a proportional integral (PI) type of servo loop (control of a VCO that can be defined as an Integrator with Gain), and will be able to follow the disturbances within a range defined by a bandwidth of the feedback loop of the PLL. In one example, following the disturbance refers to the adjustment of tape speed and/or acceleration based upon the difference between an actual buffer fill level and a buffer fill level target, with the goal of minimizing the difference.

When the loop is in LOCK, the VCO will be following the input frequency and its low frequency variations while keeping the error term to zero. However, keeping PLL frequency/phase error zero through a wide range of variation is accomplished by following the PLL clock to the data clock by adjusting the contents of the Integrator Register of the PLL servo loop. Therefore the Integrator register contents will be a function of the PLL input frequency, the DC term as well as the AC term. To properly adjust the Integrator register contents to modify by the clock to the PLL involves determining a Transfer Function relating the PLL integrator value (when in LOCK) to the ratio of input Frequency to the Nominal Frequency at which the tape was written.

An equation representing a ratio between the Input Frequency and Nominal Frequency with an oversame ratio of 1.5, and where N represents the number of bits in the Integrator register:

$$\frac{{F}_{r d}}{{F}_{0}} = - \frac{{2}^{- N}}{1.5} \cdot Integ + 1$$

In this example, the format of the Integrator Register is 24 bits, with Scale factor 23. Therefore the register represents signed numbers less than ±1.0. Therefore, considering the register as storing a signed integer requires dividing the result by 2 power 23 in order to convert it to the actual fractional value. Therefore the N in the above equation is 23.

Different PLLs may have a different transfer function, and one of ordinary skill would be able to adapt the example presented herein to account for such variations.

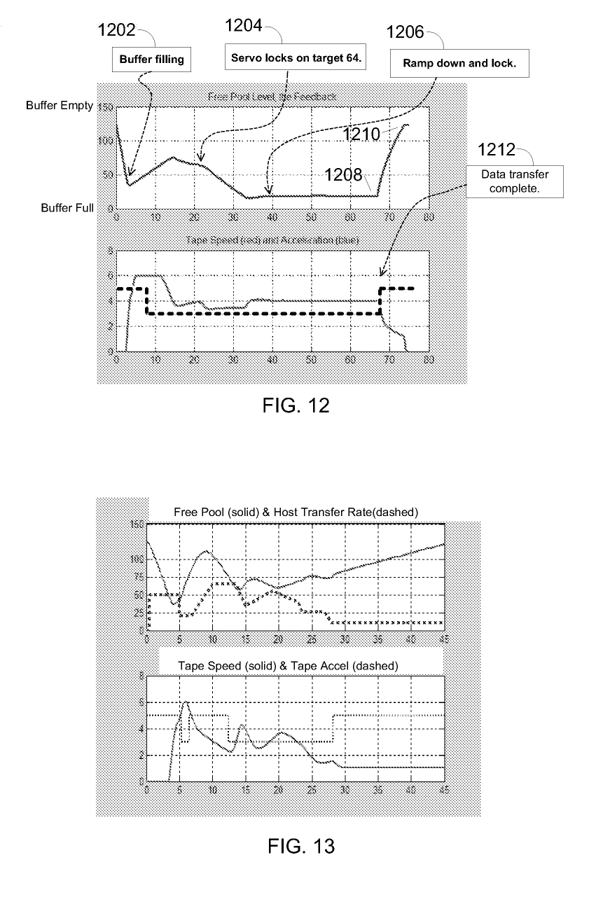

FIGS. 12 and 13 illustrate simulated operation of a system according to the above described aspects. The upper graph of FIG. 12 illustrates availability of space in the buffer over time, and the lower graph illustrates the tape speed (solid line) and the tape acceleration (dashed line) over time. In the example of FIG. 12, a first portion of the graph, indicated by the arrow from block 1202, corresponds to filling of the buffer. Note that in the upper graph of FIG. 12, the vertical axis indicates a free pool level, so that the value 0 on the vertical axis corresponds to a full buffer, and the value 150 on the vertical axis corresponds to an empty buffer. Tape motion starts when the buffer fill percentages reaches 75%, and writing starts when the fill percentage reaches 85%. Therefore, in write mode, the target buffer fill level is near full. A second portion of the graph, indicated by the arrow from block 1204, corresponds to the servo locking onto the buffer level target of 64%. The servo locks onto the 64% fill target after 23 seconds. A third portion of the graph, indicated by the arrow from block 1206, illustrates that once the servo is locked at the 64% buffer fill target, the buffer target is ramped down to a new run target of 20%. Once the buffer fill percentage reaches the new target of 20%, the servo locks again.

A portion of the lower graph, indicated by the arrow from block 1212, illustrates that when the host finishes the data transfer, e.g., because there is no more data to write, or because the host stops providing data, or the host-drive connection is lost, the buffer servo automatically ramps down while writing. The buffer level begins to decrease, i.e., empty out, at the point shown by reference number 1208. The ramp down uses a different acceleration, as shown by the decrease in the acceleration (dashed line). When the data is finished, the buffer servo executes a back hitch at the lowest speed, e.g., 1.3-1.5 meters per second. As may be seen from the graph, the buffer is maintained at a nearly full level (block 1206 until point 1208) during the data transfer.

The upper graph shown in FIG. 13 illustrates free buffer space (solid line) and host transfer rate (dashed line). The lower graph shown in FIG. 13 illustrates tape speed (solid line) and tape acceleration (dashed line). Referring to the upper graph of FIG. 13, the host data rate initially varies between to and 65 MB/s. After 28 seconds, the data rate stays at 10 MB/s, which is the lowest value. The buffer servo uses the midpoint of the buffer capacity as the target buffer fill level, since the lock condition fails. As long as buffer storage is available, the system does not disconnect the host. When the host is transferring data at the 10 MB/s rate, the system ramps down while writing, to a minimum speed of 1.33 MB/s. The system will eventually perform a back hitch, but the back hitch will be performed at the lowest speed, thereby allowing the data transfer to continue as long as possible, and maintaining the tape motion for as long as possible, so that the tape will be more likely to be moving if a subsequent data transfer is requested by the host. With the buffer empty, the host transferring data at 10 MB/s and back hitches executed at the lowest tape speed, the system will still support this low transfer rate acting as if it can be synchronized with the host. As the tape is maintained in motion at a minimum speed, the result is some number of back hitches but not excessive back hitches, and the back hitches are done at the minimum tape speed. That is, when the buffer becomes empty, the tape speed is at a minimum, e.g. 1.3-1.5 meters per second, and the time that the tape remains running, e.g., before a back hitch, is increased.

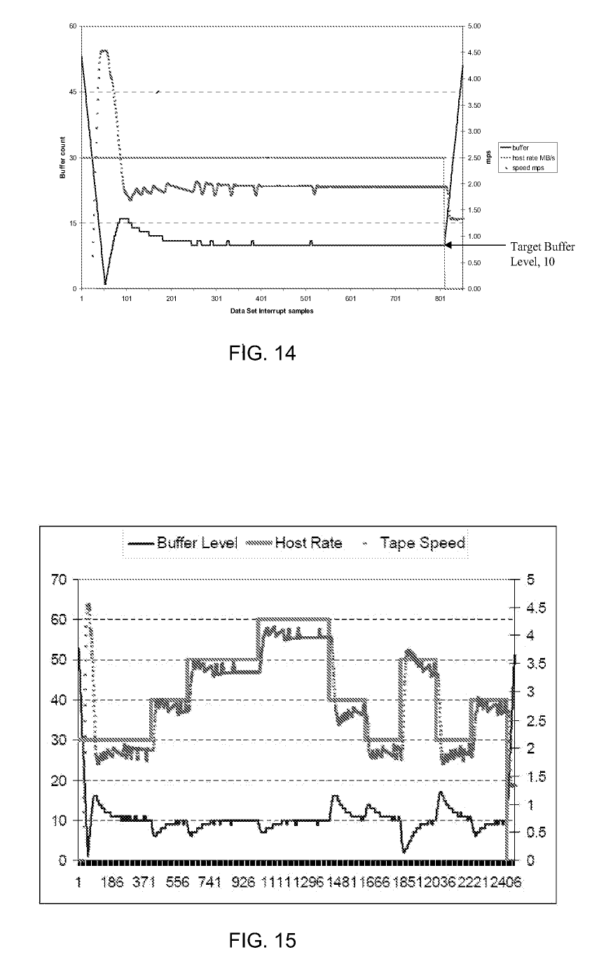

FIGS. 14-15 illustrate test results for a system according to the above-described aspects coupled with a host using a 30 MB/s interface. Various aspects and interpretation of the scenarios and configuration tested are provided on the charts. These figures illustrate certain configurations of a system and a variety of other configurations could be designed and selected, resulting in different system operation and are not to be taken as limiting in terms of system response or the like. In FIG. 14, the system starts tape motion when the buffer reaches a predetermined fill level. The buffer becomes nearly full, and the servo then starts its action. The servo has negative error, so the tape speed ramps down in control with a 5 m/s² acceleration rate. When the buffer fill level approaches the target buffer level (10), the servo stabilizes the tape speed, reaching the optimum value. When the host stops sending data, the servo detects that data transfer has stopped, and ramps the speed down to the minimum speed (1.33 meters per second).

FIGS. 12-15 illustrate that aspects of the present invention help keep a host connected for data transfer to a tape drive over a wide range of host data transfer rates, as well as accomplishing other objectives, such as reducing the speed at which hitch backs are performed. Other optimizations and algorithms can be used to achieve these objectives and other objectives.

For example, FIG. 15 illustrates that the tape speed oscillates somewhat while tracking abrupt changes in the host data rate. This ringing is not necessarily a problem and to at least some extent is attributable to the granularity of the difference measurement between the target buffer fill level and an actual buffer fill level. In this example, the granularity is an entire data segment, which is a large amount of data. Therefore, the response of the servo system could be further smoothed by providing a more granular measurement of this difference, or by adding some hysteresis to the output, such that the output does not respond immediately to changes in the difference measurement that oscillate between two data segment difference values (e.g., if near a data segment boundary, there may be some oscillation between having a difference of 1 or 2 segments.)

Other techniques for reducing system ringing or tracking the actual buffer to the target buffer may also be employed. For example, a bang-bang input can effectively model smooth a linear system response to a step input, to reduce residual oscillation around a set point. Other techniques used in control theory may be appropriate for accomplishing other objectives related to the servo control aspects presented herein.

Any drive system according to the above description may be implemented by dedicated hardware, such as ASIC circuitry, programmable processing units that can receive instructions from computer readable media, or any combination of dedicated circuitry and programmable processors. Associated support elements including sensors and actuators and appropriate interfacing components may also be used as required.

While the invention has been described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

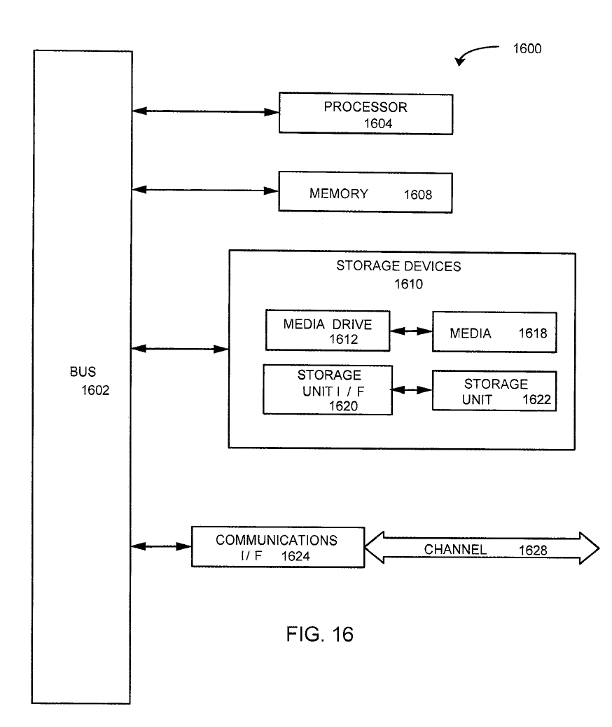

FIG. 16 illustrates a typical computing system 1600 that may be employed to implement processing functionality in embodiments of the invention. Computing systems of this type may be used in clients and servers, for example. Those skilled in the relevant art will also recognize how to implement the invention using other computer systems or architectures. Computing system 1600 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 1600 can include one or more processors, such as a processor 1604. Processor 1604 can be implemented using a general or special purpose processing engine such as, for example, a microprocessor, microcontroller or other control logic. In this example, processor 1604 is connected to a bus 1602 or other communication medium.

Computing system 1600 can also include a main memory 1608, such as random access memory (RAM) or other dynamic memory, for storing information and instructions to be executed by processor 1604. Main memory 1608 also may be used for storing temporary variables or other intermediate information during execution of instructions to be executed by processor 1604. Computing system 1600 may likewise include a read only memory (“ROM”) or other static storage device coupled to bus 1602 for storing static information and instructions for processor 1604.

The computing system 1600 may also include information storage system 1610, which may include, for example, a media drive 1612 and a removable storage interface 1620. The media drive 1612 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 1618, may include, for example, a hard disk, floppy disk, magnetic tape, optical disk, CD or DVD, or other fixed or removable medium that is read by and written to by media drive 1614. As these examples illustrate, the storage media 1618 may include a computer-readable storage medium having stored therein particular computer software or data.

In alternative embodiments, information storage system 1610 may include other similar components for allowing computer programs or other instructions or data to be loaded into computing system 1600. Such components may include, for example, a removable storage unit 1622 and an interface 1620, such as a program cartridge and cartridge interface, a removable memory (for example, a flash memory or other removable memory module) and memory slot, and other removable storage units 1622 and interfaces 1620 that allow software and data to be transferred from the removable storage unit 1618 to computing system 1600.

Computing system 1600 can also include a communications interface 1624. Communications interface 1624 can be used to allow software and data to be transferred between computing system 1600 and external devices. Examples of communications interface 1624 can include a modem, a network interface (such as an Ethernet or other NIC card), a communications port (such as for example, a USB port), a PCMCIA slot and card, etc. Software and data transferred via communications interface 1624 are in the form of signals which can be electronic, electromagnetic, optical or other signals capable of being received by communications interface 1624. These signals are provided to communications interface 1624 via a channel 1628. This channel 1628 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 1608, storage device 1618, or storage unit 1622. These and other forms of computer-readable media may be involved in storing one or more instructions for use by processor 1604, to cause the processor to perform specified operations. Such instructions, generally referred to as “computer program code” (which may be grouped in the form of computer programs or other groupings), when executed, enable the computing system 1600 to perform features or functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 1600 using, for example, removable storage drive 1614, drive 1612 or communications interface 1624. The control logic (in this example, software instructions or computer program code), when executed by the processor 1604, causes the processor 1604 to perform the functions of the invention as described herein.

It will be appreciated that, for clarity purposes, the above description has described embodiments of the invention with reference to different functional units. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units or divisions of functions for purposes of illustration are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

We claim:

1. A variable speed linear tape drive, comprising:
a driver portion for rotating a supply reel of a tape cartridge having storage media spooled therein;
a motor coupled to rotate the driver portion;
a controller configured to control the motor in accordance with a control algorithm;
an interface for one or more of sending data to and receiving data from a host; and
a buffer for storing one or more of data received from the host and data to be transmitted to the host, the buffer operable to supply a buffer fill level indication to the controller, wherein
the control algorithm is operable to generate a difference between a target buffer fill level and the buffer fill level indication and adjust at least one of an angular velocity or an acceleration of the motor to reduce the difference.

2. The tape drive of claim 1, wherein the control algorithm implements a time optimum seek and track of the selected buffer target algorithm.

3. The tape drive of claim 2, wherein the time optimum seek and track algorithm is operable to output motor control signals for angular velocity and acceleration rate.

4. The tape drive of claim 3, wherein the seek and track algorithm is operable to reduce the magnitude of the acceleration rate in response to a reduction in the magnitude of the difference.

5. The tape drive of claim 3, wherein the seek and track algorithm includes a proportional integral differential (PID) controller.

6. The tape drive of claim 3, wherein the seek and track algorithm includes an integrator with lead/lag compensation.

7. The tape drive of claim 3, wherein the seek and track algorithm includes a linear quadratic regulator.

8. The tape drive of claim 3, wherein the seek and track algorithm includes an H-Infinity control.

9. The tape drive of claim 1, wherein the target buffer fill level is selectable according to a state of either a write or a read in progress.

10. The tape drive of claim 1, wherein the state is describable by state selected from: a mid-tape state, a corner turn state, and a seek state.

11. The tape drive of claim 10, wherein the target fill level for the corner turn state is set at a relatively full level in order to reduce the buffer fill level prior to an end of the storage media, causing reversal of direction of the media.

12. A servo system for implementing a variable speed linear tape drive to read from or write to storage media in a tape cartridge, the servo system comprising:
circuitry for selecting a target fill level of a buffer operable to store at least one of read data to be transmitted to a host or data received from the host to be written to the storage media, the target fill level selected based at least on an amount of the storage media remaining in the tape cartridge;
circuitry to periodically generate an indication of an actual fill level of the buffer;
circuitry to produce a difference between the target fill level and the actual fill level; and
optimization circuitry to implement an algorithm for reducing the difference.

13. The servo system of claim 12, wherein the optimization circuitry is operable to track the actual fill level to within a tolerance of the target to achieve a lock.

14. The servo system of claim 12, wherein after achieving a lock, the optimization circuitry is operable to track the actual fill level to an end target level at a slew rate selected to avoid recorded data density mismatches on the tape.

15. In a variable speed linear tape drive system, a method for writing data to media in a cartridge, the method comprising:
storing, in a buffer, data received from a host prior to writing the data to the media;
determining that the media in the cartridge is nearing a position for reversal of a direction of movement of the media through the drive;
in response to the determination, operating the tape drive at a higher write rate to cause the buffer to become more available;
receiving data from the host in the buffer during the reversal of media movement direction; and
resuming writing the data to the host at a rate selected to at least postpone emptying the buffer.

16. The method of claim 15, wherein determining also includes determining whether the drive can operate at a higher write rate.

17. A method of operating a variable speed linear tape drive for reading from and writing to a storage tape, the method comprising:
selecting a target fill level for a buffer for storing one or more of data received from a host and data to be transmitted to the host;
generating a signal indicative of a difference between an actual fill level and the target fill level of the buffer; and
adjusting a speed of the tape for reducing the difference by using a feedback system that attempts to minimize the difference signal.

18. The method of claim 17, further comprising adjusting an acceleration of the tape.

19. The method of claim 17, further comprising selecting the target fill level based at least in part on whether the tape drive is approaching an end of the tape.

20. The method of claim 17, wherein the target fill level is a comparatively full position if the tape drive is approaching an end of the tape.

21. A method for adjusting the speed of a variable speed tape drive, the method comprising:
selecting a target speed based on one or more of an estimate of a data transfer rate from a host computer and a position of the tape during a data transfer operation accessing the tape,
the target speed selected by a servo receiving as feedback a difference between a target fill level of a buffer and an actual fill level of the buffer.

22. A computer-readable medium comprising instructions for writing data to media in a cartridge in a variable speed linear tape drive system, the instructions for:
storing, in a buffer, data received from a host prior to writing the data to the media;
determining that the media in the cartridge is nearing a position for reversal of a direction of movement of the media through the drive;
in response to the determination, operating the tape drive at a higher write rate to cause the buffer to become more available;
receiving data from the host in the buffer during the reversal of media movement direction; and
resuming writing the data to the host at a rate selected to at least postpone emptying the buffer.

23. The computer-readable medium of claim 22, wherein determining also includes determining whether the drive can operate at a higher write rate.

24. A computer-readable medium comprising instructions for operating a variable speed linear tape drive for reading from and writing to a storage tape, the instructions for:
selecting a target fill level for a buffer for storing one or more of data received from a host and data to be transmitted to the host;
generating a signal indicative of a difference between an actual fill level and the target fill level of the buffer; and
adjusting a speed of the tape for reducing the difference by using a feedback system that attempts to minimize the difference signal.

25. The computer-readable medium of claim 24, further comprising adjusting an acceleration of the tape.

26. The computer-readable medium of claim 24, further comprising selecting the target fill level based at least in part on whether the tape drive is approaching an end of the tape.

27. The computer-readable medium of claim 26, wherein the target fill level is a comparatively full position if the tape drive is approaching an end of the tape.

28. A computer-readable medium comprising instructions for adjusting the speed of a variable speed tape drive, the instructions for:
selecting a target speed based on one or more of an estimate of a data transfer rate from a host computer and a position of the tape during a data transfer operation accessing the tape,
the target speed selected by a servo receiving as feedback a difference between a target fill level of a buffer and an actual fill level of the buffer.

29. A data storage system having a controller and a tape drive, the data storage system comprising:
a closed loop servo system based upon a linearized model;
a memory buffer for storing data, wherein the memory buffer is associated with a buffer fill level indication; and
a control algorithm operable to adjust at least one of an angular velocity or an acceleration of the tape drive based upon the buffer fill level indication,
wherein the closed loop system is operable to adjust the angular velocity or acceleration independently of a transfer rate at which data is transferred between the drive and the host, and
in response to at least one disturbance, at least a portion of the memory buffer space remains available for storing data.

30. The data storage system of claim 29, wherein the at least one disturbance comprises a variation in data density, a burst of data, variation of a clock rate, a request by the host to transfer data, or a combination thereof.

31. The data storage system of claim 29, wherein the at least one disturbance does not adversely affect performance of the data storage system.

32. The data storage system of claim 29, wherein the control algorithm includes a proportional integral differential (PID) controller.

33. The data storage system of claim 32, wherein the proportional integral differential controller is associated with a bandwidth, and the closed loop servo system is operable to follow the disturbance within a range defined by the bandwidth, and wherein following the disturbance comprises adjusting at least one of an angular velocity or an acceleration of the tape drive to minimize a difference between the buffer fill level indication and a target buffer fill level.

34. The data storage system of claim 29, wherein the control algorithm includes an integrator with lead/lag compensation.

35. The data storage system of claim 29, wherein the control algorithm includes a linear quadratic regulator.

36. The data storage system of claim 29, wherein the control algorithm includes an H-Infinity control.
